(19) United States
(12) Patent Application Publication
(10) Pub. No.: US 2013/0321838 A1
(43) Pub. Date: Dec. 5, 2013

(54) INFORMATION TERMINAL CAPABLE OF REQUESTING IMAGE FORMING APPARATUS TO PERFORM PRINTING, CONTROL METHOD THEREFOR, AND STORAGE MEDIUM

(71) Applicant: CANON KABUSHIKI KAISHA, Tokyo (JP)

(72) Inventor: Takashi Ono, Inagi-shi (JP)

(73) Assignee: CANON KABUSHIKI KAISHA, Tokyo (JP)

(21) Appl. No.: 13/898,730

(22) Filed: May 21, 2013

(30) Foreign Application Priority Data
Jun. 5, 2012 (JP) 2012-127925

(51) Int. Cl. G06F 3/12

(52) U.S. Cl. CPC G06F 3/1258
USPC 358/1.13

(57) ABSTRACT

An information terminal which is capable of causing an image forming apparatus to perform printing and being intuitively operated by a user. A display section displays a print setting screen for the user to configure print settings relating to printing that is to be performed by an image forming apparatus whose image is taken by an image pickup section of the information terminal. The display section is controlled such that when an image of another image forming apparatus different from the image forming apparatus is taken by the image pickup section, information for notifying the user of a print setting unsupported by the other image forming apparatus among the print settings configured on the print setting screen is displayed.

### BACKGROUND OF THE INVENTION

1. Field of the Invention

The present invention relates to an information terminal, a control method therefor, and a computer-readable storage medium storing a program for implementing the control method.

2. Description of the Related Art

Conventionally, by reviewing a print job through a user interface displayed on a panel of an image forming apparatus and requesting another image forming apparatus to execute the print job, printing can be performed using the other image forming apparatus.

Also, when a status of an image forming apparatus is to be checked, the image forming apparatus is accessed from a PC terminal or the like via a network, and a status thereof is obtained.

Further, there have been proposed a method that takes an image of an image forming apparatus using a camera of a tablet terminal using the augment reality (AR) technique and displays the taken image of the image forming apparatus in combination with an image that represents other information (see, for example, Japanese Laid-Open Patent Publication (Kokai) No. 2005-100134).

However, when a print job being currently configured or being currently executed in an image forming apparatus is to be executed by another image forming apparatus, it is necessary to know in advance where an image forming apparatuses displayed on a user interface is.

Moreover, a user needs to determine what type of functions an image forming apparatus has and select any of the functions, and this is inconvenient for the user.

Further, according to the method proposed in Japanese Laid-Open Patent Publication (Kokai) No. 2005-100134, status information on an image forming apparatus is merely displayed, and no solutions as to print job manipulation are proposed.

### SUMMARY OF THE INVENTION

The present invention provides an information terminal which is capable of causing an image forming apparatus to perform printing and being intuitively operated by a user, a control method therefor, and a computer-readable storage medium storing a program for implementing the control method.

Accordingly, a first aspect of the present invention provides an information terminal comprising an image pickup unit, a display unit configured to display a print setting screen for a user to configure print settings relating to printing that is to be performed by an image forming apparatus whose image is taken by the image pickup unit, and a control unit configured to control the display unit such that when an image of another image forming apparatus different from the image forming apparatus is taken by the image pickup unit, information for notifying the user of a print setting unsupported by the other image forming apparatus among the print settings configured on the print setting screen is displayed.

Accordingly, a second aspect of the present invention provides a control method for an information terminal having an image pickup unit, comprising a display step of displaying a print setting screen for a user to configure print settings relating to printing that is to be performed by an image forming apparatus whose image is taken by the image pickup unit, and a control step of providing control such that when an image of another image forming apparatus different from the image forming apparatus is taken by the image pickup unit, information for notifying the user of a print setting unsupported by the other image forming apparatus among the print settings configured on the print setting screen is displayed.

Accordingly, a third aspect of the present invention provides a non-transitory computer-readable storage medium storing a program for causing a computer to implement a control method for an information terminal having an image pickup unit, the method comprising a display step of displaying a print setting screen for a user to configure print settings relating to printing that is to be performed by an image forming apparatus whose image is taken by the image pickup unit, and a control step of providing control such that when an image of another image forming apparatus different from the image forming apparatus is taken by the image pickup unit, information for notifying the user of a print setting unsupported by the other image forming apparatus among the print settings configured on the print setting screen is displayed.

According to the present invention, when the information terminal which is capable of causing the image forming apparatus to perform printing takes an image of another image forming apparatus different from the image forming apparatus, information indicative of a print setting unsupported by the other image forming apparatus is displayed on the display unit, and as a result, the information terminal can be intuitively operated by the user based on the information displayed on the display unit.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of an image forming system according to an embodiment of the present invention.

FIG. 2 is a diagram schematically showing an arrangement of an information terminal appearing in FIG. 1.

FIG. 3 is a diagram schematically showing an arrangement of image forming apparatuses appearing in FIG. 1.

FIG. 4 is a flowchart showing the procedure of an identification process carried out by a CPU of the information terminal appearing in FIG. 1.

FIG. 5 is a flowchart showing the procedure of a device information sending process carried out by a server appearing in FIG. 1.

FIG. 6 is a view showing an identification marker drawn on the image forming apparatuses appearing in FIG. 1.

FIG. 7 is a view showing a composite image displayed on a display unit of the information terminal appearing in FIG. 2.

FIGS. 8A to 8C are views showing data formats used in the processes in FIGS. 5 and 6.

FIG. 9 is a flowchart showing the procedure of a print setting process carried out by the CPU of the information terminal appearing in FIG. 2.

FIG. 10 is a flowchart showing the procedure of a printing process carried out by a CPU of the image forming apparatuses appearing in FIG. 3.

FIG. 11 is a flowchart showing an exemplary image forming apparatus that is am object whose image is to be taken.

FIG. 12 is a view showing an example in which an image pickup area appearing in FIG. 11 is displayed on the display unit.

FIG. 13 is a flowchart showing another exemplary image forming apparatus that is an object whose image is to be taken.

FIG. 14 is a view showing an example in which an image pickup area appearing in FIG. 13 is displayed on the display unit.

FIG. 15 is a view showing a data format for print setting support information obtained in step S1214 in FIG. 9.

FIG. 16 is a flowchart showing the procedure of a post print request process carried out by the CPU appearing in FIG. 2.

FIG. 17 is a flowchart showing the procedure of a post change print job information display process in FIG. 16.

FIG. 18 is a flowchart showing the procedure of a printing process carried out by the CPU of the image forming apparatuses appearing in FIG. 3 in response to a printing execution request.

FIG. 19 is a flowchart showing the procedure of a data sending process carried out in the image forming apparatus before the change by the CPU of the image forming apparatus appearing in FIG. 3.

FIG. 20 is a view showing an exemplary image forming apparatus that is an object whose image is to be taken after printing is requested.

FIG. 21 is a view showing an example in which an image pickup area appearing in FIG. 20 is displayed on the display unit of the information terminal.

FIG. 22 is a view showing another exemplary image forming apparatus that is an object whose image is to be taken after printing is requested.

FIG. 23 is a view showing an example in which an image pickup area appearing in FIG. 22 is displayed on the display unit of the information terminal.

FIG. 24A is a view showing a data format for print job information, and FIG. 24B is a view showing a data format for print setting support information.

### DESCRIPTION OF THE EMBODIMENTS

The present invention will now be described in detail with reference to the drawings showing an embodiment thereof.

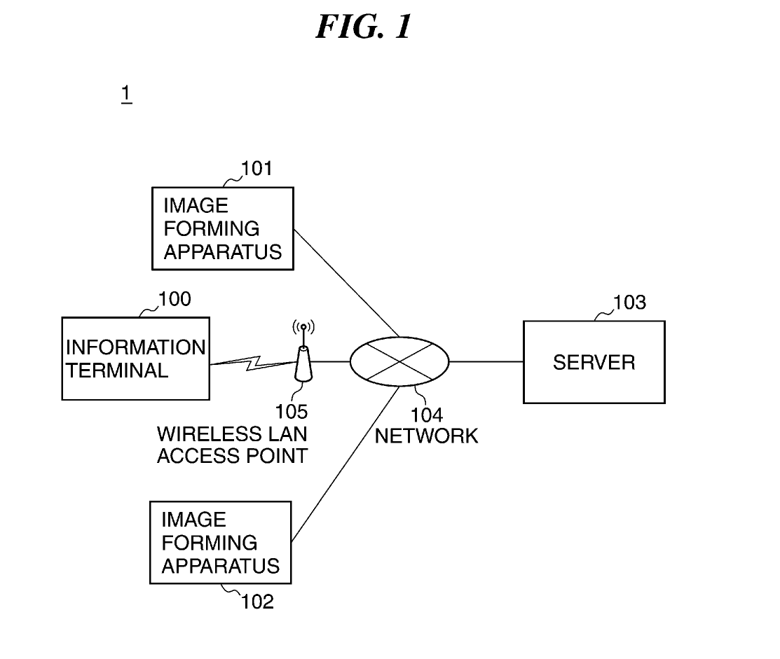

FIG. 1 is a diagram schematically showing an arrangement of an image forming system 1 according to an embodiment of the present invention.

Referring to FIG. 1, the image forming system 1 is comprised of image forming apparatuses 101 and 102, an information terminal 100, a server 103, a network 104, and a wireless LAN access point 105.

The image forming apparatuses 101 and 102, the information terminal 100, and the server 103 are capable of communicating with each other via the network 104 and the wireless LAN access point 105.

The information terminal 100 has a display such as an LCD, a camera using a CCD or the like, and a communication function such as a wireless LAN. A status of a print job, a preview image, a setting screen, and so on are displayed on the display.

In accordance with instructions from the information terminal 100, the image forming apparatuses 101 and 102 perform printing and send statuses of the image forming apparatuses 101 and 102. In the following description, the word “device” is used, and this represents the image forming apparatuses 101 and 102 in the present embodiment. It should be noted that in general, a larger number of image forming apparatuses, other electronic equipment, and so on may be targeted.

The server 103 manages information on the image forming apparatuses 101 and 102 and sends the information in accordance with requests.

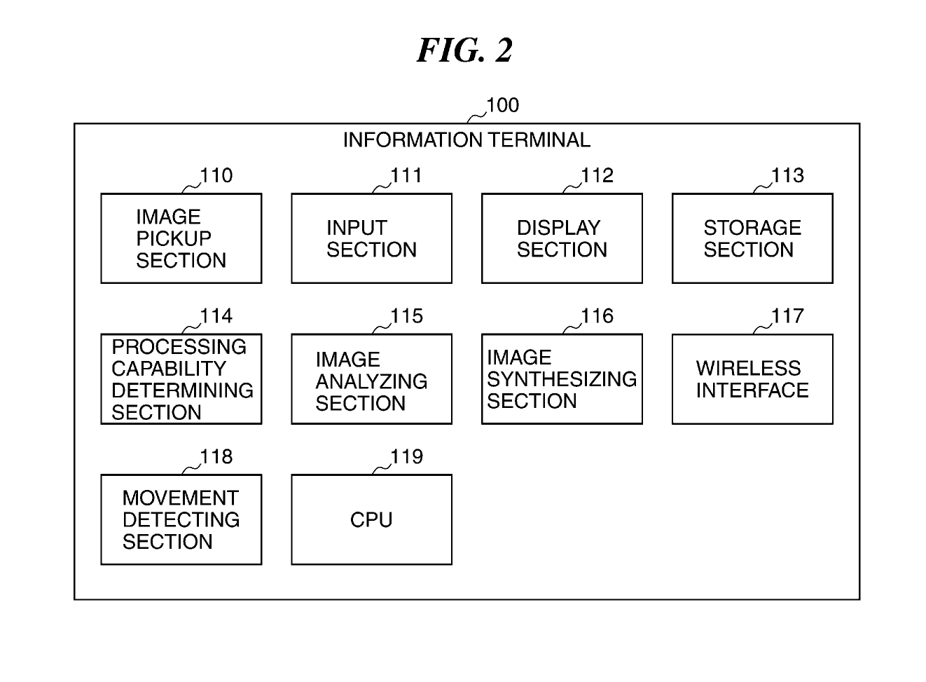

FIG. 2 is a diagram schematically showing an arrangement of the information terminal 100 appearing in FIG. 1.

Referring to FIG. 2, a CPU 119 controls the entire information terminal 100. An image pickup section 110 (image pickup unit) takes an image of a subject using a solid-state image pickup device such as a CCD to obtain a taken image that represents the subject. An input section 111 has a touch panel integrated with a display section 112, physical buttons, and so on, and receives operation inputs from a user.

The display section 112 (display unit) displays taken images obtained by the image pickup section 110 and information from the image forming apparatuses 101 and 102. A storage section 113 stores images, various information, and temporary information required for processing.

A processing capability determining section 114 compares settings of a print job with settings that can be supported by the image forming apparatuses 101 and 102. An image analyzing section 115 analyzes a taken image. Based on an identification marker drawn on the image forming apparatuses 101 and 102, the image analyzing section 115 is capable of determining an image forming apparatus whose image has been taken. The identification marker will be described later.

An image synthesizing section 116 synthesizes an image taken by the image pickup unit 110 and various information into one image. A wireless interface 117 accesses the image forming apparatuses 101 and 102 and the server 103, which are connected to the network 104, via the wireless LAN access point 105.

A movement detecting section 118 detects the amount of movement and the direction of movement using a gyro sensor when the user has moved the information terminal 100 or changed the orientation of the information terminal 100.

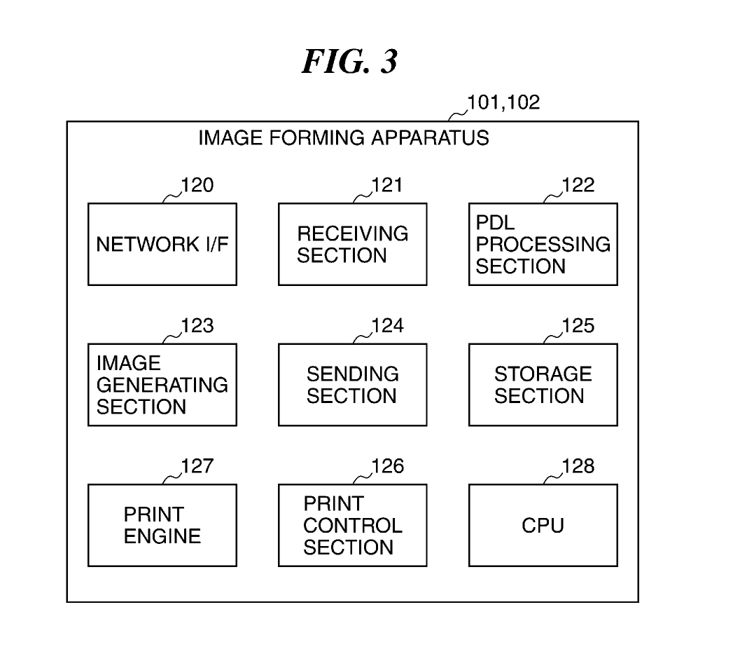

FIG. 3 is a diagram schematically showing an arrangement of the image forming apparatuses 101 and 102 appearing in FIG. 1.

Referring to FIG. 3, a CPU 128 controls the entire image forming apparatus. A network interface 120 is an interface for accessing the information terminal 100, other image forming apparatuses, and so on via the network 104.

A receiving section 121 obtains information via the network interface 120 and stores the obtained information in a storage section 125.

A PDL processing section 122 processes PDL (page description language) data, which is information stored in the storage section 125, to create intermediate data and stores the created intermediate data in the storage section 125.

An image generating section 123 processes intermediate data, which is created by the PDL processing section 122, to thus convert the same into image data. A sending section 124 sends statuses, data, and so on to the information terminal 100 and other image forming apparatuses via the network interface 120 in response to requests from the information terminal 100 and other image forming apparatuses.

PDL data, image data, information from external devices, and temporary information for use in processing are stored in the storage section 125. A print control section 126 manages processing on PDL data, control of output to a print engine 127, and processing statues of print jobs.

The print engine 127 prints image data, which is generated by the image generating section 123, on sheets under the control of the print control section 126.

It should be noted that the image forming apparatuses 101 and 102 are configured such that one image forming apparatus obtains PDL data and image data being processed by the other image forming apparatus and outputs the obtained data to the print engine 127 of the other image forming apparatus.

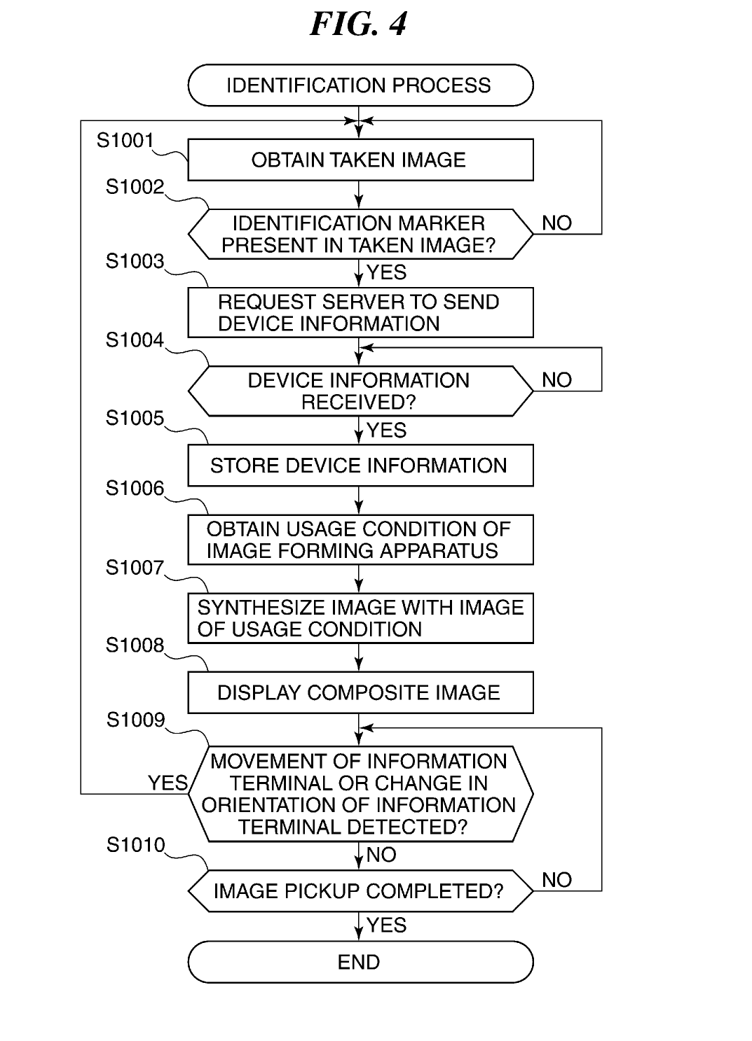

FIG. 4 is a flowchart showing the procedure of an identification process carried out by the CPU 119 of the information terminal 100 appearing in FIG. 2.

Referring to FIG. 4, the CPU 119 causes the image pickup section 110 to take an image (step S1001) and causes the image analyzing section 115 to determine whether or not there is an identification marker in the taken image (step S1002).

When, as a result of the determination in the step S1002, there is no identification marker in the taken image (NO in the step S1002), the process returns to the step S1001.

On the other hand, when, as a result of the determination in the step S1002, there is an identification marker in the taken image (YES in the step S1002), the CPU 119 obtains a marker ID (identification information), to be described later, from the identification marker, and by using the obtained marker ID, requests the server 103 to send device information (step S1003). This step S1003 corresponds to a first obtaining unit that obtains identification information for identifying an image forming apparatus whose image has been taken by the image pickup section 110 of the information terminal 100. Also, in the step S1003, the CPU 119 obtains the marker ID from the identification marker whose image has been taken by the image pickup section 110.

Upon receiving the device information from the server 103 (step S1004), the CPU 119 stores the received device information in the storage section 113 (step S1005). The CPU 119 gives an image forming apparatus included in the received device information a request to send a usage condition of the image forming apparatus and obtains a usage condition of the image forming apparatus (step S1006). This usage condition is indicative of whether or not the image forming apparatus is currently performing printing.

Then, the CPU 119 causes the image synthesizing section 116 to synthesize the taken image with an image indicative of the usage condition of the image forming apparatus (step S1007) and cause the display section 112 to display a composite image obtained as a result of the synthesis (step S1008).

Then, the CPU 119 causes the movement detecting section 118 to determine whether or not it has detected a movement of the information terminal 100 or a change in the orientation of the information terminal 100 (step S1009). When, as a result of the determination in the step S1009, a movement of the information terminal 100 or a change in the orientation of the information terminal 100 has been detected (YES in the step S1009), the process returns to the step S1001. It should be noted that when the user holds the information terminal 100 with his/her hand, it is unlikely that the information terminal 100 is completely motionless. Therefore, the determination result may be positive (YES) in the step S1009 when a movement of the information terminal 100 or a change in the orientation of the information terminal 100 equal to or greater than a predetermined threshold value has been detected.

On the other hand, when, as a result of the determination in the step S1009, a movement of the information terminal 100 or a change in the orientation of the information terminal 100 has not been detected (NO in the step S1009), the CPU 119 determines whether or not image taking has been completed (step S1010).

When, as a result of the determination in the step S1010, image pickup has not been completed (NO in the step S1010), the process returns to the step S1009. When image pickup has been completed (YES in the step S1010), the CPU 119 terminates the present process.

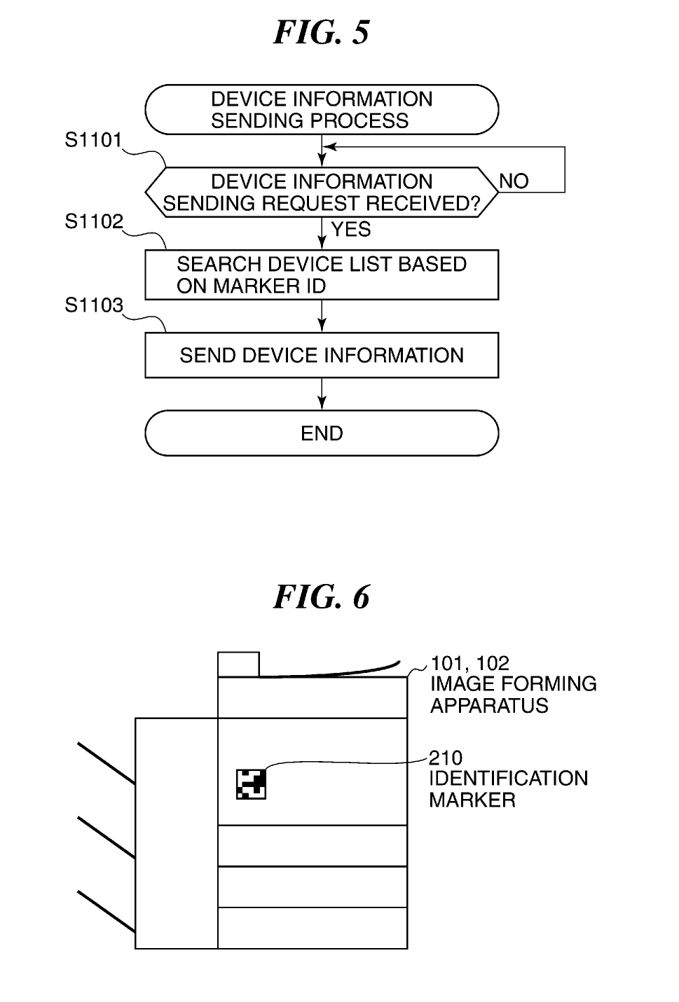

FIG. 5 is a flowchart showing the procedure of a device information sending process carried out by the server 103 appearing in FIG. 1.

Referring to FIG. 5, upon receiving a device information sending request from the information terminal 100 (YES in the step S1101), the server 103 retrieves device information matching a marker ID included in the device information sending request from a device list (step S1102). A description will be given later of this device list.

When the retrieval in the step S1102 is completed, the server 103 sends device information on an image forming apparatus matching the marker ID to the information terminal 100 (step S1103) and terminates the present process.

FIG. 6 is a view showing an identification marker 210 drawn on the image forming apparatuses 101 and 102 appearing in FIG. 1.

The identification marker 210 is an identification image indicative of identification information (marker ID) of an image forming apparatus and attached to the image forming apparatus. The identification marker 210 appearing in FIG. 6 is a two-dimensional code, but is not limited to a two-dimensional code as long as it can be identified.

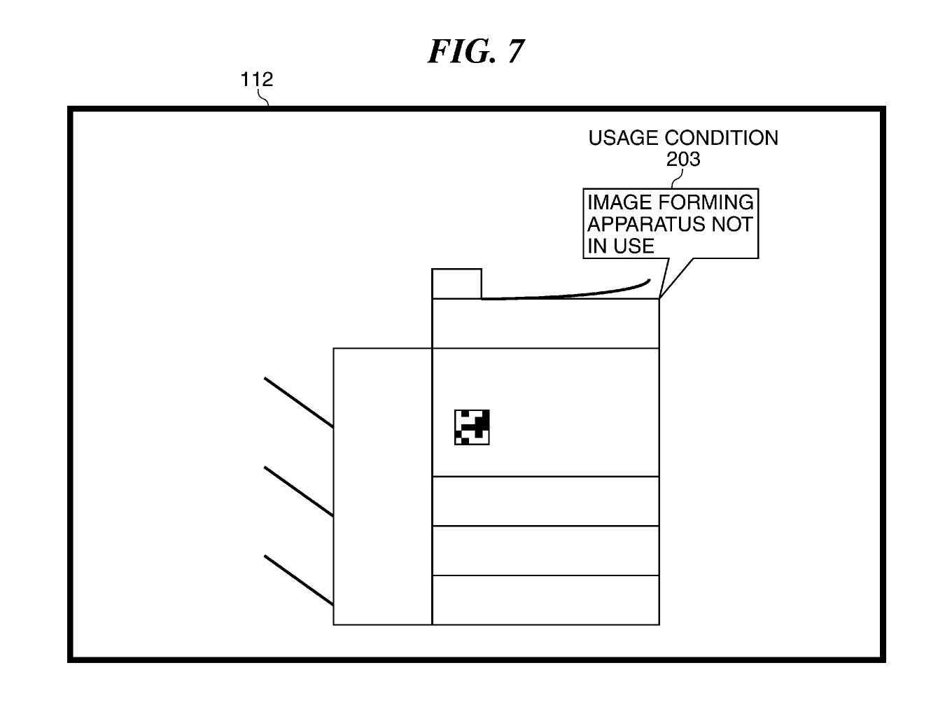

FIG. 7 is a view showing an exemplary composite image displayed on the display section 112 of the information terminal 100 appearing in FIG. 2.

Referring to FIG. 7, an image forming apparatus and its usage condition 203 are displayed on the display section 112. In this composite image, a message saying “image forming apparatus not in use” is displayed as the usage condition 203 to indicate that the image forming apparatus is not in use.

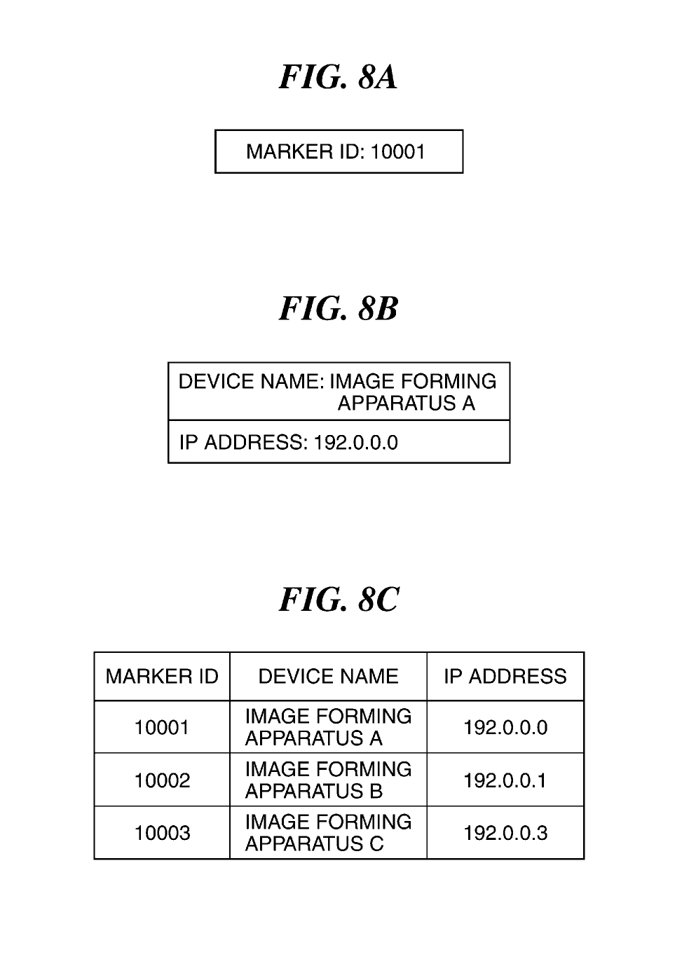

FIGS. 8A to 8C are views showing data formats for information used in the processes in FIGS. 5 and 6.

FIG. 8A shows a format for a device information sending request, and as shown in this figure, it is comprised of a marker ID.

FIG. 8B shows a format for device information, and as shown in this figure, it is comprised of a device name and an IP address of a device represented by the device name.

FIG. 8C shows a format for a device list, and as shown in this figure, it is comprised of a marker ID, a device name, and an IP address. As with the device information sending process described above with reference to FIG. 5, a device mama and an IP address can be retrieved based on a marker ID by using the device list.

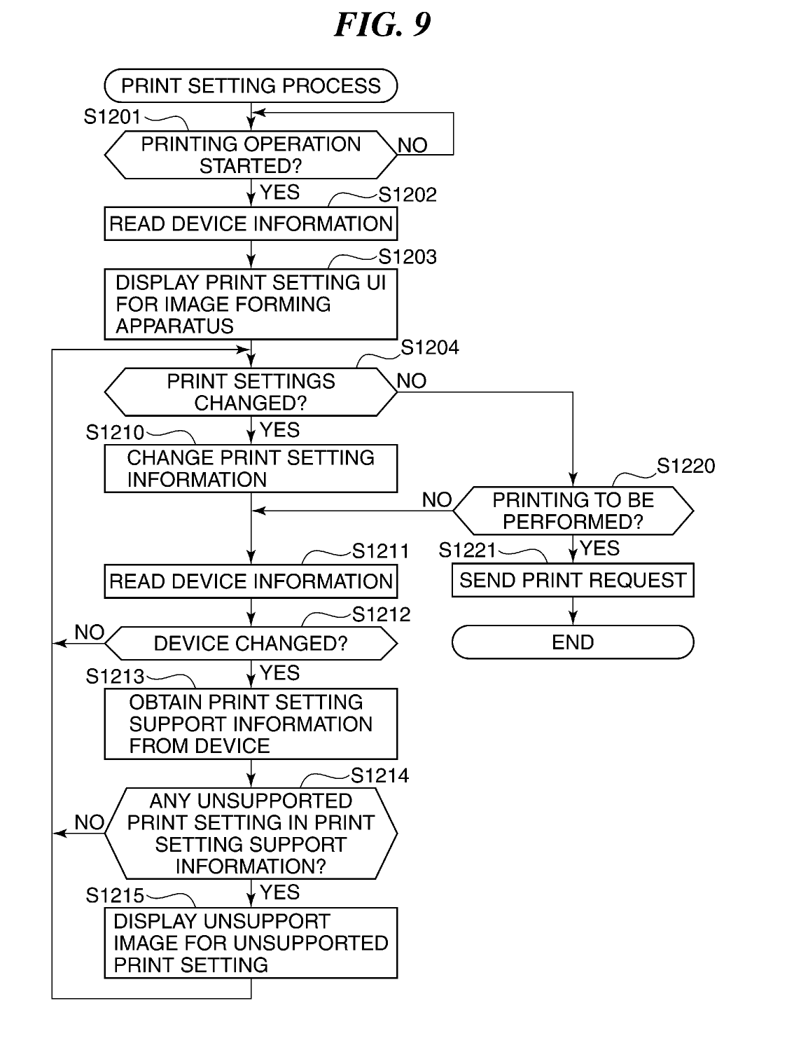

FIG. 9 is a flowchart showing the procedure of a print setting process carried out by the CPU 119 of the information terminal 100 appearing in FIG. 2.

Referring to FIG. 9, when a printing operation is started by the user (YES in step S1201), the CPU 119 reads device information stored in the storage section 113 (step S1202). Then, the CPU 119 refers to a device name of an image forming apparatus in the device information and displays a print setting UI (print setting screen) (step S1203). The print setting UI displayed here is a print setting UI for an image forming apparatus whose image is being taken by the information terminal 100. This print setting UI may be stored in advance in the storage section 113 of the information terminal 100 or may be obtained from the server 103.

The CPU 119 then determines whether or not print settings have been changed on the print setting UI (step S1204). Here, the print settings are settings such as a sheet size, a page layout, a print method, a sheet discharge method, and a sheet discharge destination.

When, as a result of the determination in the step S1204, the print settings have been changed (YES in the step S1204), the CPU 119 changes print setting information stored in the storage section 113 (step S1210).

The CPU 119 then reads device information stored in the storage section 113 (step S1211). Then, the CPU 119 compares a device name in the read device information with the device name in the device information read in the step S1202.

As a result of the comparison, the CPU 119 determines whether or not the device has been changed (step S1212). When, as a result of the determination in the step S1212, the device has not been changed (NO in the step S1212), the process returns to the step S1204. It should be noted that when an image of the other image forming apparatus is taken by the image pickup unit 110 of the information terminal 100 after the printing operation is started, device information on the device after the change is stored in the storage section 113 in the step S1005 in FIG. 4. Therefore, even when the device is changed after the printing operation is started, the determination result is positive (YES) in the step S1212.

On the other hand, when, as a result of the determination in the step S1212, the device has been changed (YES in the step S1212), the CPU 119 obtains print setting support information from the device (step S1214). The print setting support information is information indicative of print settings that can be supported by the device (the image forming apparatus 101 or the image forming apparatus 102).

Then, based on the print setting support information, the CPU 119 then determines whether or not in print setting information, there is any print setting unsupported by the other image forming apparatus (step S1214).

When, as a result of the determination in the step S1214, there is any unsupported print setting (YES in the step S1214), the CPU 119 displays an unsupport image in the unsupported print setting (step S1215) and returns to the step S1204. This step S1215 corresponds to a control unit that controls the display section 112 such that when an image of the other image forming apparatus is taken by the image pickup section 110, the display section 112 displays information for notifying the user of a print setting unsupported by the other image forming apparatus among a plurality of print settings configurable on a print setting screen.

On the other hand, when, as a result of the determination in the step S1214, there is no print setting unsupported by the other image forming apparatus (NO in the step S1214), the process returns to the step S1204.

On the other hand, when, as a result of the determination in the step S1204, the print settings have not been changed (NO in the step S1204), the CPU 119 determines whether or not to perform printing (step S1220). When, as a result of the determination in the step S1220, printing is not to be performed (NO in the step S1220), the CPU 119 proceeds to the step S1211.

On the other hand, when, as a result of the determination in the step S1220, printing is to be performed (YES in the step S1220), the CPU 119 sends a print request as well as print data to the image forming apparatus which is the device (step S1221) and terminates the present process.

According to the process in FIG. 9, when an image of the other image forming apparatus is taken by the image pickup section 110, a process described hereafter is carried out. Specifically, for a print setting unsupported by the other image forming apparatus among a plurality of print settings configurable on a print setting screen, an unsupport image indicating that the print setting is unsupported is displayed on the display section 112. Thus, when the user changes a target whose image is to be taken to another image forming apparatus, an unsupport image indicating a print setting unsupported by the targeted other image forming apparatus is displayed, enabling the user to intuitively perform operation.

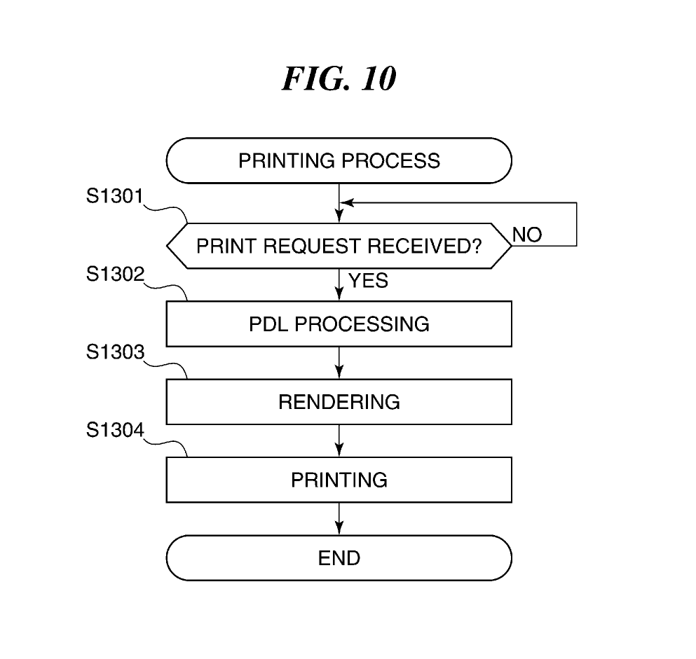

FIG. 10 is a flowchart showing the procedure of a printing process carried out by the CPU 128 of the image forming apparatuses 101 and 102 appearing in FIG. 3.

Referring to FIG. 10, upon receiving print data as well as a print request from the information terminal 100 (YES in step S1301), the CPU 128 stores the print data (PDL data) received by the receiving section 121 in the storage section 125 and then causes the PDL processing section 122 to convert the stored PDL data into intermediate code, which in turn is stored in the storage section 125 (step S1302).

The CPU 128 then causes the image generating section 123 to perform rendering on the intermediate code stored in the storage section 125 (step S1303) to convert the same into image data to be printed. The CPU 128 causes the print control section 126 to output the generated image data to the print engine 127 and perform printing (step S1304) and then terminates the present process.

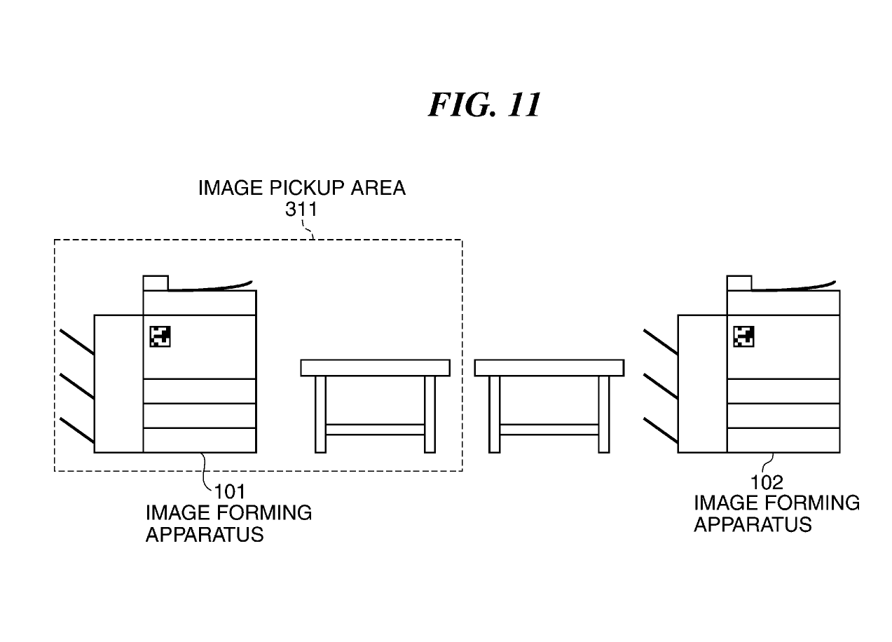

FIG. 11 is a view showing an example of the image forming apparatuses 101 and 102 whose images are to be taken.

Referring to FIG. 11, an image pickup area 311 is an area whose image is taken by the image pickup section 110 of the information terminal 100.

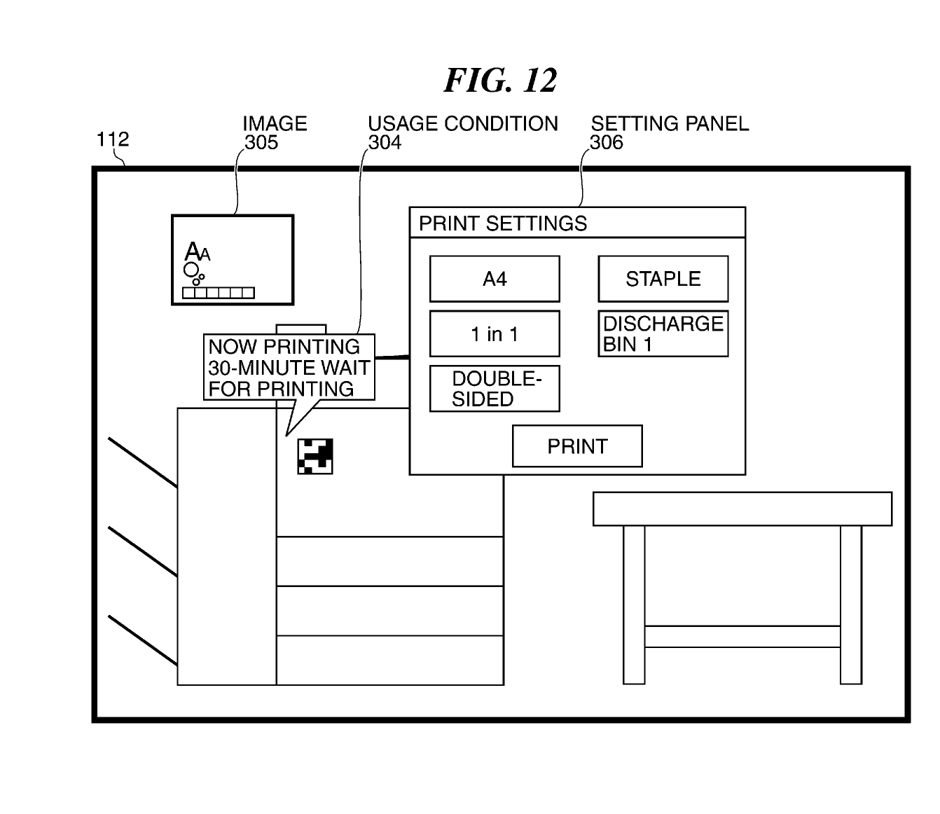

FIG. 12 is a view showing an example in which the image pickup area 311 appearing in FIG. 11 is displayed on the display section 112 of the information terminal 100.

Referring to FIG. 12, the usage condition 304 of the image forming apparatus 101 obtained in the step S1006, an image to be printed 305, and a setting panel (print setting UI) 306 are synthesized into a taken image by the image synthesizing section 116, and a composite image obtained as a result is displayed. Thus, the print setting UI is a print setting screen for the user to configure a plurality of print settings relating to printing.

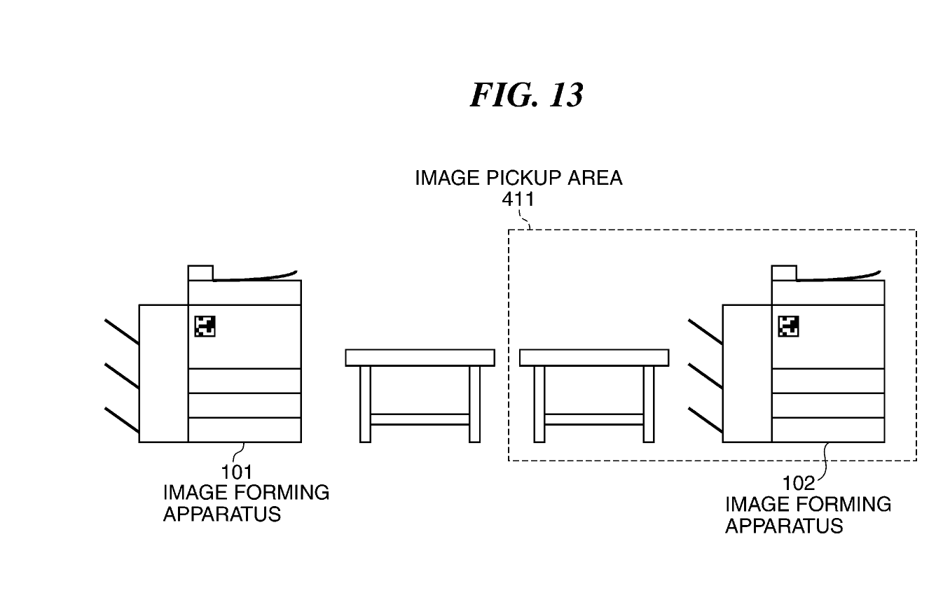

FIG. 13 is a flowchart showing another example of the image forming apparatuses 101 and 102 whose image is to be taken.

Referring to FIG. 13, an image pickup area 411 is an area whose image is taken by the image pickup section 110 of the information terminal 100.

This indicates that the image forming apparatus 102 is caused to become a subject by changing the orientation of the information terminal 100 in the state shown in FIG. 12.

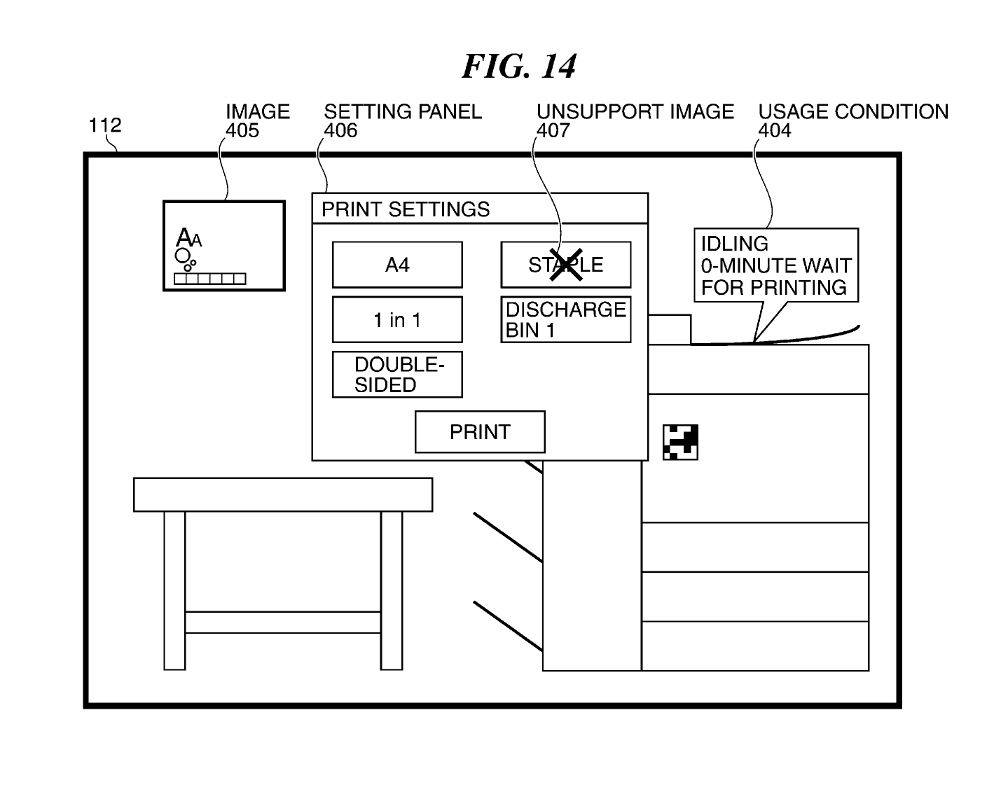

FIG. 14 is a view showing an example in which the image pickup area 411 appearing in FIG. 13 is displayed on the display section 112 of the information terminal 100.

Referring to FIG. 14, as with FIG. 12, an image to be printed 405, a setting panel 406, and a usage condition 404 of the image forming apparatus 102 are displayed.

Also, unsupport information 407 indicative of a print setting determined to be unsupported by the image forming apparatus 102 in the step S1214 is displayed.

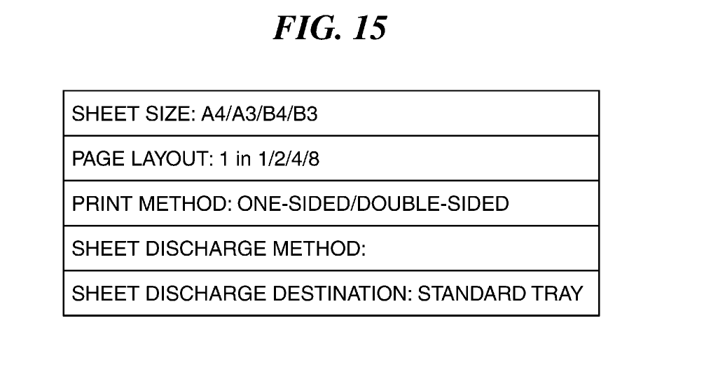

FIG. 15 is a view showing a data format for the print setting support information obtained in the step S1214 in FIG. 9.

Referring to FIG. 15, a format for the print setting support information is comprised of a sheet size, a page layout, a print method, a sheet discharge method, and a sheet discharge destination.

Examples of the sheet size include a regular sheet size and a user-defined size. The page layout is a designation to perform one or more pages on a sheet. The print method is a designation to perform printing on one or both sides of a sheet. The sheet discharge method is sorting of pages, stapling, or the like. The sheet discharge destination is a standard tray, a sheet discharge bin of a finisher, or the like.

As described hereinabove, according to the present embodiment, when the image forming apparatus that is to perform printing is desired to be changed while or after print settings are configured, the user can easily manipulate a print job by orienting the information terminal 100 toward another image forming apparatus without performing complicated operations.

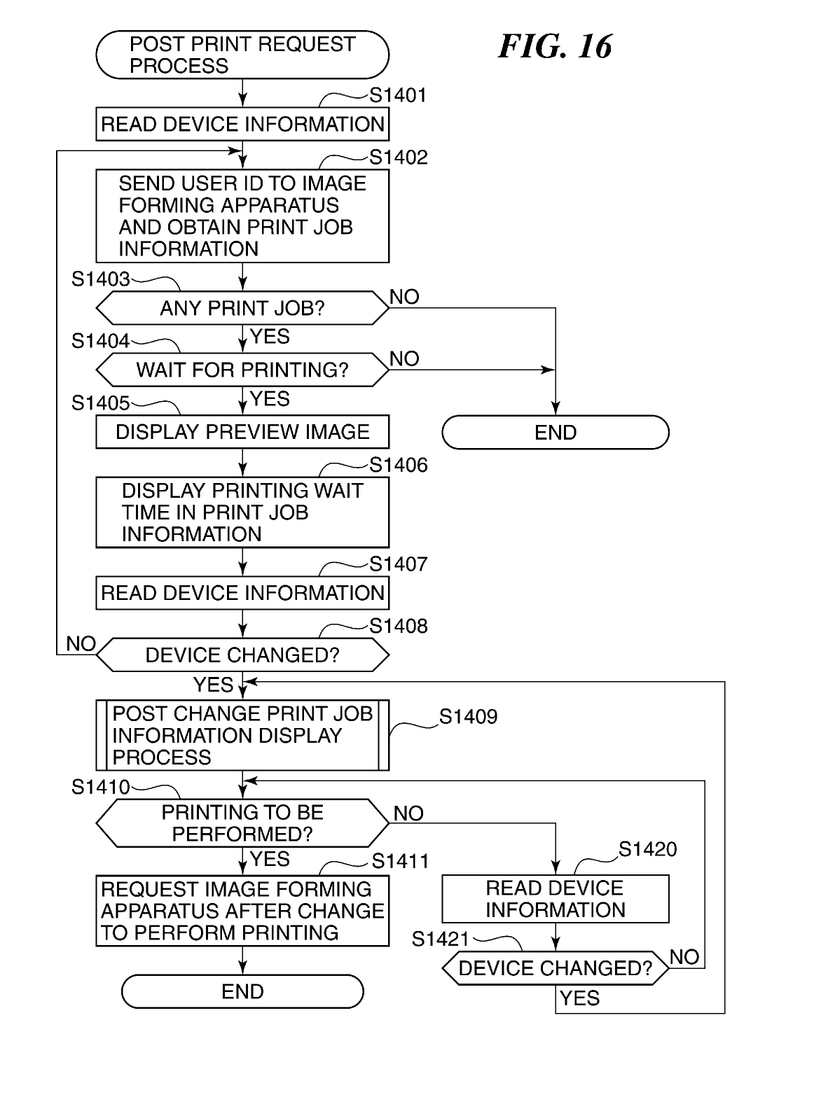

FIG. 16 is a flowchart showing the procedure of a post-print request process carried out by the CPU 119 of the information terminal 100 appearing in FIG. 2.

Referring to FIG. 16, the CPU 119 reads device information stored in the storage section 113 in the step S1005 in FIG. 4 (step S1401). The CPU 119 then obtains print job information from an image forming apparatus by sending a user ID of the information terminal 100 to the image forming apparatus using an IP address included in the device information (step S1402). A description will be given later of the print job information.

Then, based on the obtained print job information, the CPU 119 determines whether not there is a print job (step S1403).

When, as a result of the determination in the step S1403, there is no print job (NO in the step S1403), the CPU 119 terminates the present process.

On the other hand, when, as a result of the determination in the step S1403, there is a print job (YES in the step S1403), the CPU 119 determines whether not the print job is waiting for printing (step S1404).

When, as a result of the determination in the step S1404, the print job is not waiting for printing (NO in the step S1404), the CPU 119 terminates the present process.

On the other hand, when, as a result of the determination in the step S1404, the print job is waiting for printing (YES in the step S1404), the CPU 119 obtains a preview image from the print job information and displays the same on the display section 112 (step S1405).

Further, the CPU 119 obtains a wait time in the print job information and displays the same on the display section 112 (step S1406). The CPU 119 then reads device information stored in the storage section 113 (step S1407).

Then, the CPU 119 compares a device name in the read device information with a device name in the device information read in the step S1401.

As a result of the comparison, the CPU 119 determines whether or not the device has been changed (step S1408). When, as a result of the determination in the step S1408, the device has not been changed (NO in the step S1408), the process returns to the step S1402.

On the other hand, when, as a result of the determination in the step S1408, the device has been changed (YES in the step S1408), the CPU 119 carries out a post change print job information display process in which it displays print job information on the image forming apparatus after the change (step S1408).

Then, the CPU 119 determines whether or not to perform printing (step S1410). When, as a result of the determination in the step S1410, printing is not to be performed (NO in the step S1410), the CPU 119 reads device information stored in the storage section 113 (step S1420).

Then, the CPU 119 compares a device name in the read device information with a device name in the device information read in the step S1407.

As a result of the comparison, the CPU 119 determines whether or not the device has been changed (step S1421). When, as a result of the determination in the step S1421, the device has not been changed (NO in the step S1421), the process returns to the step S1410.

On the other hand, when, as a result of the determination in the step S1421, the device has been changed (YES in the step S1421), the process returns to the step S1409.

When as a result of the determination in the step S1410, printing is to be performed (YES in the step S1410), the CPU 119 sends a printing execution request to the image forming apparatus which is the device (step S1411) and terminates the present process.

Referring to FIG. 16, as long as an image forming apparatus requested to carry out a printing process according to print settings configured by the user on a print setting screen has not yet carried out the requested printing process, it is possible to cause another image forming apparatus to carry out the printing process.

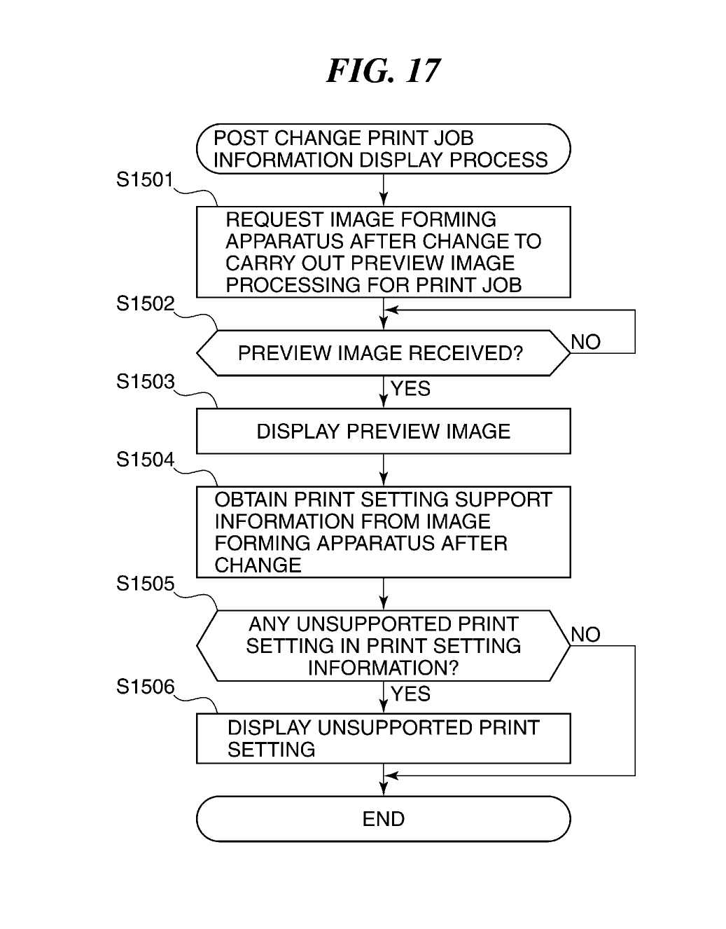

FIG. 17 is a flowchart showing the procedure of the post change print job information display process in FIG. 16.

Referring to FIG. 17, the CPU 119 requests the image forming apparatus after the change to carry out preview image processing for the print job (step S1501). Then, upon receiving a preview image from the image forming apparatus after the change (step S1502), the CPU 119 displays the preview image on the display section 112 (step S1503).

Further, the CPU 119 obtains print setting support information from the image forming apparatus after the change (step S1504). This step S1504 corresponds to a second obtaining unit that obtains print setting support information indicative of print settings supported by another image forming apparatus that is the image forming apparatus after the change.

Then, based on the print setting support information, CPU 119 determines whether or not there is any unsupported print setting in print setting information (step S1505).

When as a result of the determination in the step S1505, there is any unsupported print setting (YES in the step S1505), the CPU 119 displays an unsupport image 407 for the unsupported print setting (step S1506) and terminates the present process.

On the other hand, when as a result of the determination in the step S1505, there is no unsupported print setting (NO in the step S1505), the CPU 119 terminates the present process.

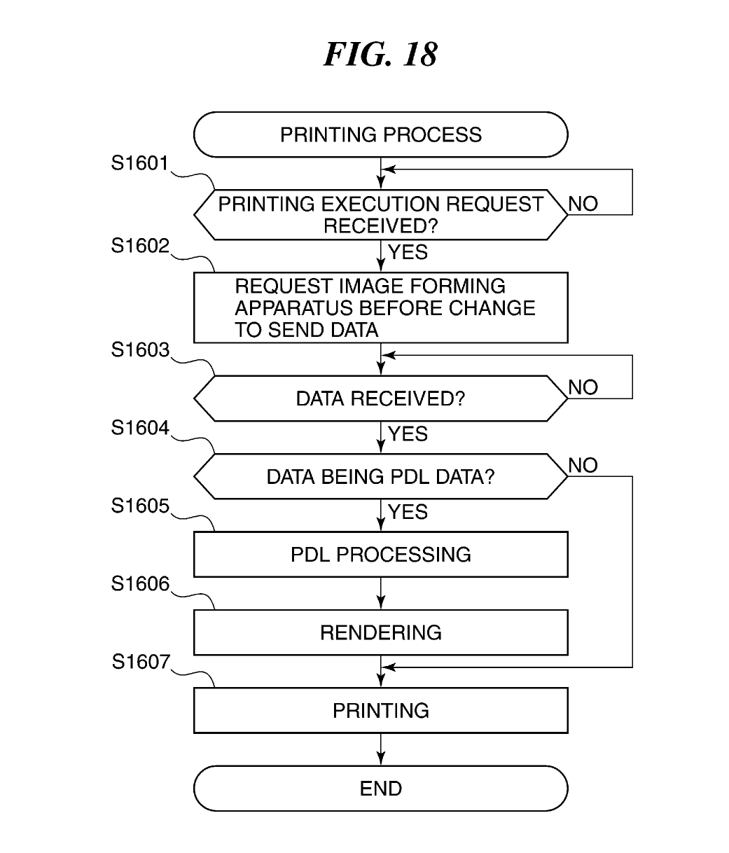

FIG. 18 is a flowchart showing the procedure of a printing process carried out by the CPU 128 of the image forming apparatus after the change in response to a printing execution request.

Referring to FIG. 18, upon receiving a printing execution request from the information terminal 100 (YES in step S1601), the CPU 128 refers to information on the image forming apparatus before the change in the printing execution request and requests the image forming apparatus before the change to send data on a print job (step S1602).

Upon receiving data from the image forming apparatus before the change (YES in step S1603), the CPU 128 determines whether or not the received data is PDL data (step S1604).

When as a result of the determination in the step S1604, the received data is not PDL data (NO in the step S1604), the process proceeds to step S1607. Here, it is assumed that when the received data is not PDL data, the received data is image data obtained as a result of rendering.

On the other hand, when the received data is PDL data (YES in the step S1604), the CPU 128 causes the PDL processing section 122 to convert the PDL data into intermediate code, which in turn is stored in the storage section 125 (step S1605).

The CPU 128 then causes the image generating section 123 to perform rendering on the intermediate code stored in the storage section 125 (step S1606) to convert the same into image data to be printed. The CPU 128 then causes the print control section 126 to output the generated image data or the image data after rendering received from the image forming apparatus before the change to the print engine 127 and perform printing (step S1607) and terminates the present process.

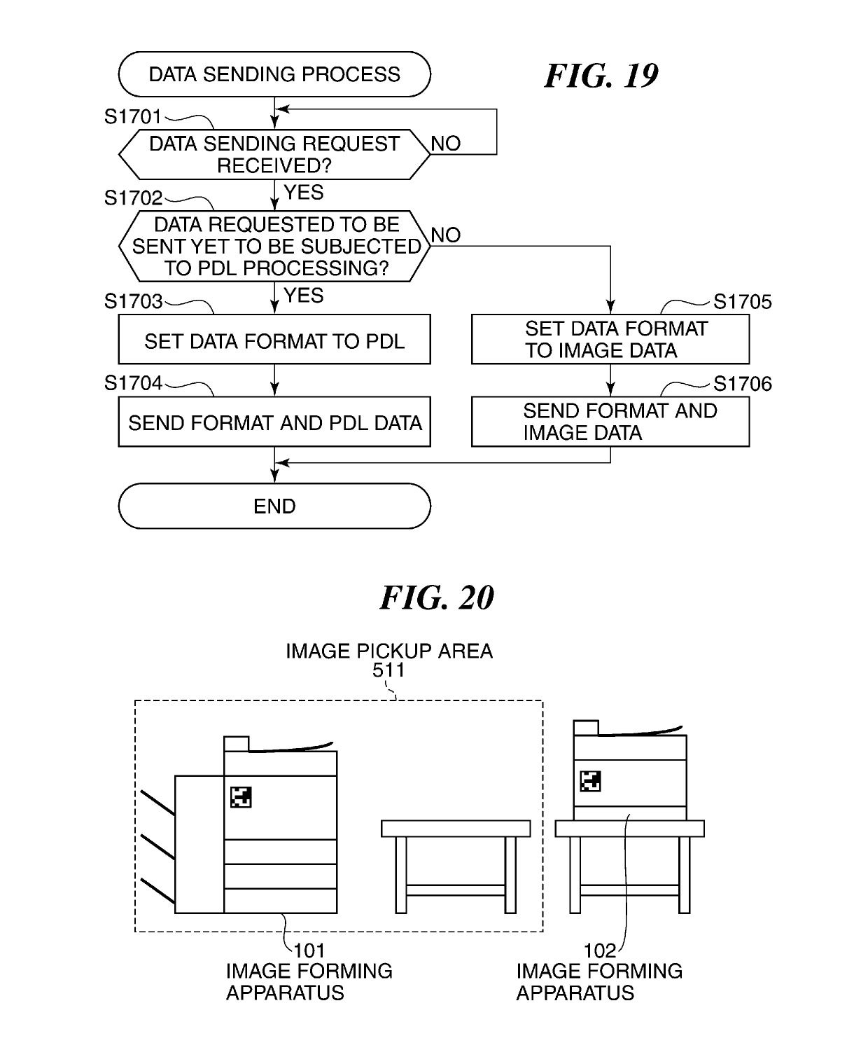

FIG. 19 is a flowchart showing the procedure of a data sending process carried out by the CPU 128 of the image forming apparatus before the change.

Referring to FIG. 19, upon receiving a data sending request from the image forming apparatus before the change (YES in step S1701), the CPU 128 causes the print control section 126 to determine whether or not data required to be sent has yet to be subjected to PDL processing (step S1702).

When as a result of the determination in the step S1702, data required to be sent has yet to be subjected to PDL processing (YES in the step S1702), the CPU 128 sets a format for the data to PDL (step S1703). Then, the CPU 128 sends the format for the data to be sent and PDL data (step S1704) and terminates the present process.

On the other hand, when, as a result of the determination in the step S1702, data required to be sent has been subjected to PDL processing (NO in the step S1702), the CPU 128 sets a format for the data to image data (step S1705). Then, the CPU 128 sends the format for the data to be sent and image data (step S1706) and terminates the present process.

FIG. 20 is a view showing an example of the image forming apparatus 101 or 102 whose image is to be taken after printing is requested.

Referring to FIG. 20, an image pickup area 511 represents an area whose image is taken by the image pickup unit 110 of the information terminal 100.

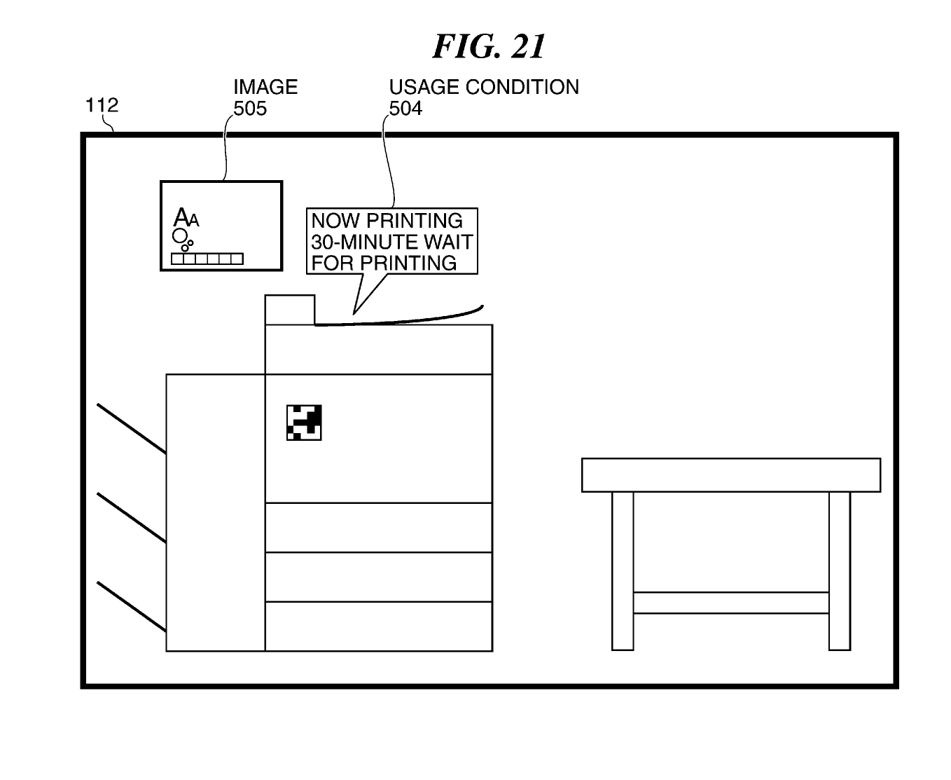

FIG. 21 is a view showing an example in which the image pickup area 511 appearing in FIG. 20 is displayed on the display section 112 of the information terminal 100.

Referring to FIG. 21, the preview image 505 obtained in the step S1405 and the usage condition 504 indicative of the wait time for processing obtained in the step S1406 are synthesized into a taken image by the image synthesizing section 116, and a composite image obtained as a result is displayed.

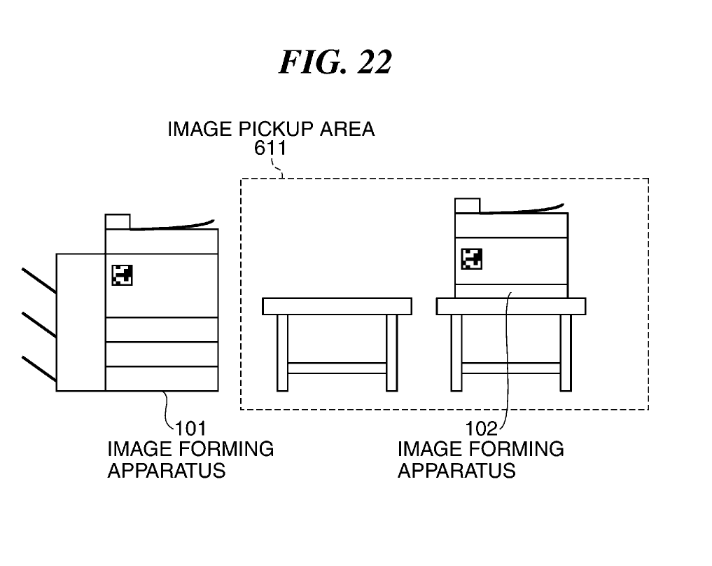

FIG. 22 is a view showing another example of the image forming apparatus 101 or 102 whose image is to be taken after printing is requested.

Referring to FIG. 22, an image pickup area 611 is an area whose image is taken by the image pickup section 110 of the information terminal 100.

This indicates that the image forming apparatus 102 is caused to become a subject by changing the orientation of the information terminal 100 in the state shown in FIG. 21.

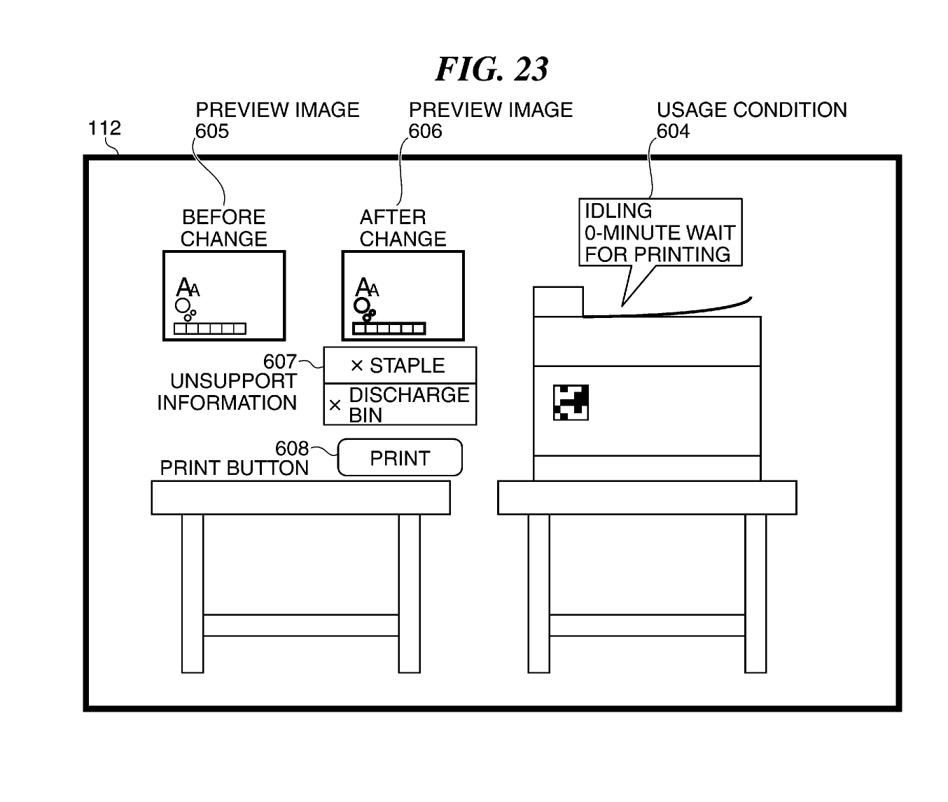

FIG. 23 is a view showing an example in which the image pickup area 611 appearing in FIG. 22 is displayed on the display section 112.

Referring to FIG. 23, a preview image 606 obtained during processing by the image forming apparatus 102 as well as the preview image 505 before the change is displayed. Also, the wait time for processing indicated by the usage condition 604 is updated, and further, unsupport information 607, which is indicative of a print setting determined as being unsupported by the image forming apparatus 102 as a result of the determination in the step S1505 in FIG. 17, and a print button 608 for instructing execution of printing are displayed.

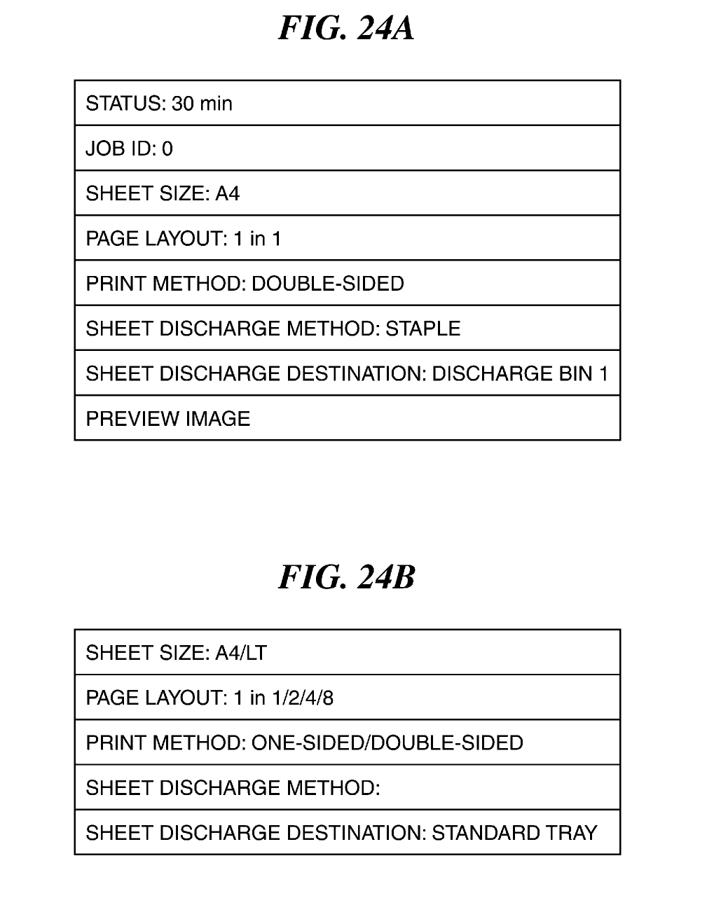

FIG. 24A is a view showing a data format for print job information, and FIG. 24B is a view showing a data format for print setting support information.

Referring to FIG. 24A, the data format for the print job information is comprised of a status, a job ID, print settings (a sheet size, a page layout, a print method, a sheet discharge method, and a sheet discharge destination), and a preview image.

The status is a wait time for which a print job waits to be processed. The job ID is an ID assigned to the print job. The preview image is image data obtained when the print job is processed by the image forming apparatus 101 or reduced image data.

The print setting support information shown in FIG. 24B is different from the print setting support information shown in FIG. 15 because the devices are different. The format for the print setting support information is comprised of a printable sheet size, a page layout, a print method, a sheet discharge method, and a sheet discharge destination.

Examples of the sheet size include a regular sheet size and a user-defined size. The page layout is a designation to perform printing of one or more pages on a sheet. The print method is a designation to perform printing on one or both sides of a sheet. The sheet discharge method is sorting of pages, stapling, or the like. The sheet discharge destination is a standard tray, a sheet discharge bin of a finisher, or the like. As indicated by the unsupport information 607 in FIG. 7, the image forming apparatus 102 according to the present embodiment has no finisher, and hence it is impossible to output sheets to a stapler or a discharge bin designated for a print job.

As described hereinabove, according to the present embodiment, when the image forming apparatus that is to perform printing is desired to be changed after execution of printing is requested, the user can easily request execution of printing using another image forming apparatus by orienting the information terminal 100 toward the other image forming apparatus and taking an image thereof without performing any complicated operations.

Thus, according to the present embodiment, when performing printing operations, by orientating the camera of the information terminal toward another image forming apparatus without the need to perform any complicated operations, the other image forming apparatus can be easily caused to perform a print job being currently configured or currently executed.

Moreover, because it can be automatically determined whether or not a result configured by the image forming apparatus before the change can be obtained by the other image forming apparatus after the change, and also, images output from different image forming apparatuses can be reviewed in advance by looking at preview images, occurrence of print errors in a case where the device is changed from one image forming apparatus to another image forming apparatus can be prevented.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-127925 filed Jun. 5, 2012, which is hereby incorporated by reference herein in its entirety.

What is claimed is:

1. An information terminal comprising:
an image pickup unit;
a display unit configured to display a print setting screen for a user to configure print settings relating to printing that is to be performed by an image forming apparatus whose image is taken by said image pickup unit; and
a control unit configured to control said display unit such that when an image of another image forming apparatus different from the image forming apparatus is taken by said image pickup unit, information for notifying the user of a print setting unsupported by the other image forming apparatus among the print settings configured on the print setting screen is displayed.

2. An information terminal according to claim 1, further comprising a first obtaining unit configured to obtain identification information for identifying the image forming apparatus whose image is taken by said image pickup unit,
wherein based on the identification information, said display unit displays a print setting screen provided for the image forming apparatus whose image is taken by said image pickup unit.

3. An information terminal according to claim 2,
wherein an identification image is attached to the image forming apparatus, and
said first obtaining unit obtains the identification information from the identification image taken by said image pickup unit.

4. An information terminal according to claim 1, further comprising:
a second obtaining unit configured to obtain print setting support information indicative of print settings supported by the other image forming apparatus; and
a determination unit configured to, based on the print setting support information, determine whether there is any print setting unsupported by the other image forming apparatus among the print settings configured on the print setting screen,
wherein, when said determination unit determines that there is any print setting unsupported by the other image forming apparatus, said control unit controls said display unit such that information for notifying the user of the print setting unsupported by the other image forming apparatus is displayed.

5. An information terminal according to claim 4, wherein said second obtaining unit obtains the print setting support information from the other image forming apparatus.

6. An information terminal according to claim 1, further comprising a sending unit configured to send a print request based on the print settings to the image forming apparatus whose image is taken by said image pickup unit.

7. An information terminal according to claim 1,
wherein said display unit further displays a preview image for printing based on the print settings.

8. An information terminal according to claim 7,
wherein said display unit further displays the preview image received from the image forming apparatus whose image is taken by said image pickup unit.

9. A control method for an information terminal having an image pickup unit, comprising:
a display step of displaying a print setting screen for a user to configure print settings relating to printing that is to be performed by an image forming apparatus whose image is taken by the image pickup unit; and
a control step of providing control such that when an image of another image forming apparatus different from the image forming apparatus is taken by the image pickup unit, information for notifying the user of a print setting unsupported by the other image forming apparatus among the print settings configured on the print setting screen is displayed.

10. A non-transitory computer-readable storage medium storing a program for causing a computer to implement a control method for an information terminal having an image pickup unit, the method comprising:
a display step of displaying a print setting screen for a user to configure print settings relating to printing that is to be performed by an image forming apparatus whose image is taken by the image pickup unit; and
a control step of providing control such that when an image of another image forming apparatus different from the image forming apparatus is taken by the image pickup unit, information for notifying the user of a print setting unsupported by the other image forming apparatus among the print settings configured on the print setting screen is displayed.
